(19) United States
(12) Patent Application Publication
(10) Pub. No.: US 2014/0206321 A1
(43) Pub. Date: Jul. 24, 2014

(54) METHODS FOR AUTOMATICALLY REPLYING TO PHONE CALLS AND TEXT MESSAGES

(71) Applicant: Bibhudendu Mohapatra, San Diego, CA (US)

(72) Inventor: Bibhudendu Mohapatra, San Diego, CA (US)

(21) Appl. No.: 13/747,102

(22) Filed: Jan. 22, 2013

(51) Int. Cl. H04W 4/12

(52) U.S. Cl. CPC H04W 4/12
USPC 455/413; 455/466

(57) ABSTRACT

A method of automatically replying to incoming phone calls is provided. The method includes enabling automatic reply on a cellular phone of a user; generating a voice message for the automatic reply; associating the voice message with at least one phone number; detecting the at least one number when an incoming call from the at least one phone number is received at the cellular phone; and playing the voice message associated with the at least one number to a person making the incoming call from the at least one phone number without requiring manual input from the user of the cellular phone when the incoming call from the at least one phone number is being received. A method of automatically replying to incoming text messages is also provided.

### FIELD

This invention relates to automatic replies to incoming communications, and in particular, to automatic replies to incoming phone calls and text messages.

### BACKGROUND

Users of cellular phones typically receive multiple calls and text messages per day. In order to respond to incoming phone calls and to read incoming text messages, a cell phone user typically needs to have the cell phone in his or her possession, and either physically manipulate the cell phone, or control the cell phone via voice commands. When a cell phone user has the cell phone in his or her possession and is available to speak with the person making an incoming phone call, the cell phone user may manually manipulate the phone (e.g., by clicking a button on the phone or flipping the phone open) to personally answer the incoming phone call. If the cell phone user cannot, or does not wish to speak with the person calling the user, the user may either click a button on the phone to send the incoming phone call straight to voicemail, or do nothing and let the incoming call ring until it goes to voicemail.

The incoming phone calls do not always require an immediate response and the user can respond to a voicemail left by the person making the incoming phone call when convenient for the user. However, sometimes the person calling or sending a text message needs to hear back soon or immediately. Of course, people receiving phone calls and text messages are not always available to pick up an incoming phone call and may not be able to answer a text message for hours. For example, cell phone users may not be available to answer a phone call or a text message because they are busy at work (e.g., in a meeting, on a phone call), in a place where cellular voice/data service is sporadic and/or unavailable (e.g., an elevator or an underground parking structure), or simply in a place that is too loud for an incoming phone call or text message to be heard. Other times, cellular phone users may be unavailable because they are away from their phone (e.g., playing a sport or exercising in a gym).

Presently available cell phones are equipped with a voicemail function that plays a recorded message from the user to the people calling the user, and permits the callers to leave a recorded message for the user, which the user will listen to, and have the option to respond at a time convenient for the user. For example, as shown in FIG. 1, a cellular phone 10 can receive an incoming call from a cellular phone 12, or from a land line phone 14, and if the owner of the cellular phone 10 is unavailable, an identical pre-recorded voicemail message selected by the owner of the cellular phone 10 will be played to both the person calling from the cellular phone 12 and the person calling from the land line phone 14. The presently available cell phones generally permit the user, upon noticing an incoming phone call, to manually click a button on the cellular phone to cause the phone to immediately start playing the generic voicemail to the caller, and some cell phones allow the user to manually click on the cell phone as a call is coming in to send a text message to the caller. However, the presently available phones require the presence and physical action of the cell phone user when the incoming call is being received.

The presently available cell phones do not include an option indicate to those sending text messages to the cell phone user that the cell phone user is away from the phone, not available to respond, or that the cell phone is off because the user is, for example, on an airplane for the next eight hours. Instead, the person sending an incoming text message only gets a response when the cell phone user has the cell phone in his or her possession and is available to view and respond to the received text message by, for example, manually manipulating the phone to personally key in or dictate a response to the received text message. For example, as shown in FIG. 2, incoming text messages may be received at cellular phone 20 from cellular phones 22 and 24, and the owner of the cellular phone 10 can manually send a responsive text message to the cellular phones 22 and 24.

Accordingly, methods are needed for automatically replying to incoming phone calls and text messages to permit cell phone users to provide instantaneous feedback to those calling and/or sending text messages to the user without requiring the user to observe and/or manipulate the cell phone as the phone calls and/or text messages are being received.

### SUMMARY

In one embodiment, a method of automatically replying to incoming phone calls comprises enabling automatic reply on a cellular phone of a user; generating a voice message for the automatic reply; associating the voice message with at least one phone number; detecting the at least one number when an incoming call from the at least one phone number is received at the cellular phone; and playing the voice message associated with the at least one number to a person making the incoming call from the at least one phone number without requiring manual input from the user of the cellular phone when the incoming call from the at least one phone number is being received.

The enabling of the automatic reply may further comprise silencing a ringer on the cellular phone associated with the incoming phone call.

The enabling of the automatic reply on the cellular phone may include enabling the automatic reply on the cellular phone prior to the incoming phone call being received at the cellular phone.

In one approach, the generating of the voice message comprises selecting one of a plurality of voice messages stored on the cellular phone. In another approach, the generating of the voice message comprises recording a new voice message for storage on the cellular phone.

The associating of the voice message with the at least one phone number can further comprise defining a single phone number for receiving the voice message when calling the cellular phone of the user.

The associating of the voice message with the at least one phone number can further comprise defining a group of phone numbers for receiving the voice message when calling the cellular phone of the user. In one form, the group of numbers is selected from one or more of the following groups: family, friends, acquaintances, and work-related.

The detecting of the at least one number when a call is received at the cellular phone can comprise detecting a name associated with the at least one number calling the cellular phone.

The playing of the voice message associated with the at least one number can include playing the voice message automatically after a predetermined number of incoming phone rings.

In another embodiment, a method of automatically replying to incoming text messages comprises enabling automatic reply on a cellular phone of a user; generating a text message for the automatic reply; associating the text message with at least one phone number; detecting the at least one number when an incoming text from the at least one phone number is received at the cellular phone; and sending the text message associated with the at least one number to a person that sent the incoming text from the at least one number without requiring manual input from the user of the cellular phone after the incoming text message from the at least one phone number is received.

The enabling of the automatic reply can include silencing one of a sound function and a vibrate function associated with the incoming text message on the cellular phone.

The enabling of the automatic reply on the cellular phone can include enabling the automatic reply prior to the incoming text message being received at the cellular phone.

In one approach, the generating of the text message can include storing a plurality of text messages on the cellular phone and selecting one of the plurality of text messages stored on the cellular phone. In another approach, the generating of the text message can comprise inputting a new text message for storage on the cellular phone.

In one approach, the associating of the text message with the at least one phone number can include defining a single phone number for receiving the text message when sending a text message to the cellular phone of the user. In another approach, the associating the text message with the at least one phone number can include defining a group of phone numbers for receiving the text message when sending a text message to the cellular phone of the user.

The group of phone numbers can be defined from a list of contacts of the user stored on the cellular phone. The group of numbers can be selected from one or more of the following groups: family, friends, acquaintances, and work-related.

The detecting of the at least one number when a text message is received at the cellular phone can comprise detecting a name associated with the at least one number from which the incoming text message is sent to the cellular phone.

The above described methods of automatically replying to incoming phone calls and text messages provide numerous advantages over the presently used methods. One advantage is that a user does not have to manipulate his or her cellular phone as the incoming call or text message is being received to reply to the incoming phone call or text message. Another advantage is that the methods described herein permit cell phone users to generate personalized automatic replies for various intended recipients instead of relying on a single generic reply (e.g., voicemail or out-of-the-office message) that is generated in response to all phone calls. Further advantages will be appreciated by those of ordinary skill in the art with reference to the following drawings, detailed description, and claims.

### BRIEF DESCRIPTION OF THE DRAWINGS

FIG. 1 is a schematic diagram showing exemplary voice communications between several phones according to the prior art;

FIG. 2 is a schematic diagram showing exemplary text message communications between several cellular phones according to the prior art;

FIG. 3 is a schematic diagram showing voice communications between several phones according to an embodiment of the present invention;

FIG. 4 is a flow diagram illustrating options for setting up automatic reply to voice and/or text messages on a cellular phone according to an embodiment of the present invention;

FIG. 5 is a flow diagram illustrating additional options for setting up automatic reply to voice and/or text messages on a cellular phone according to an embodiment of the present invention; and

FIG. 6 is a flow diagram illustrating additional options for setting up automatic reply to text messages on a cellular phone according to an embodiment of the present invention.

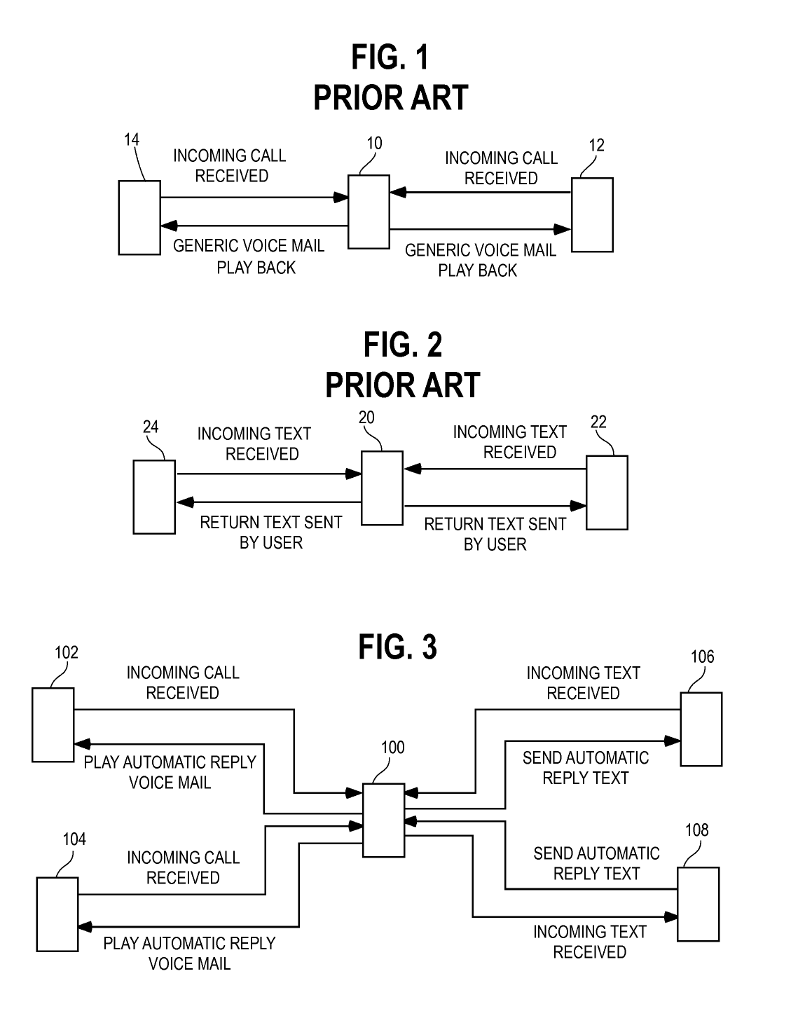

### DETAILED DESCRIPTION

Reference will now be made in detail to the present preferred embodiments of the invention, examples of which are illustrated in the accompanying drawings.

Generally, cellular phones described herein can be set up to automatically reply to one or more incoming calls and/or one or more text messages at times when the users of these cellular phones are unavailable. With automatic reply enabled, the cellular phones can, upon recognizing the phone numbers from which the incoming calls originate, play pre-selected stored voice messages and/or send pre-selected stored text messages associated with the phone numbers from which the incoming calls and/or the incoming text messages originate without requiring any manual input from the users of the cellular phones when the calls and/or text messages are being received.

With reference to FIG. 3, an exemplary cellular phone 100 is equipped with an automatic reply function, which can be enabled via the methods described in more detail below. The cellular phone 100, which is enabled with an automatic reply function, can receive one or more incoming calls, for example, from a cellular phone 102, or from a land line phone 104. Similarly, the cellular phone 100 can receive one or more text messages from cellular phones 106 and 108. It will be appreciated that the phone 100 is shown to be receiving phone calls from one cellular phone 102 and one land line phone 104 and text messages from two cellular phones 106 and 108 by way of example only, and that the cellular phone 100 can receive phone calls and text messages from a virtually unlimited number of cellular or other phones. Furthermore, it will be appreciated that FIG. 3 shows the cellular phone 100 as responding to incoming calls with automatic voice messages and to incoming text messages with automatic text messages by way of example only, and that the cellular phone 100 may be enabled via the method described herein to automatically respond to incoming phone calls with a personalized text message pre-selected by the user and/or to automatically respond to incoming text messages with a phone call that plays a personalized text message pre-recorded by the user.

If a call from phone 102 (or phone 104) is received when the user of the cellular phone 100 is away from the cellular phone 100, or otherwise unavailable, the cell phone 100 automatically plays a voicemail message pre-recorded by the user of the phone 100 and associated with the phone number of the phone 102 (or phone 104). As such, the person calling from the phone 102 (or phone 104) will get a personalized voice message from the user of the cellular phone 100 even when the user of the cellular phone 100 is unavailable instead of having to leave a voicemail and waiting for a response call. Similarly, if a text message from phone 106 (or phone 108) is received when the user of the cellular phone 100 is away from the cellular phone 100, or otherwise unavailable, the cell phone 100 automatically sends a text message pre-generated by the user of the phone 100 and associated with the phone number of the phone 106 (or phone 108). As such, the person texting from the phone 106 (or phone 108) will get a personalized text message from the user of the cellular phone 100 even when the user of the cellular phone 100 is unavailable instead of waiting for the user of cellular phone 100 to become available to send a responsive text message.

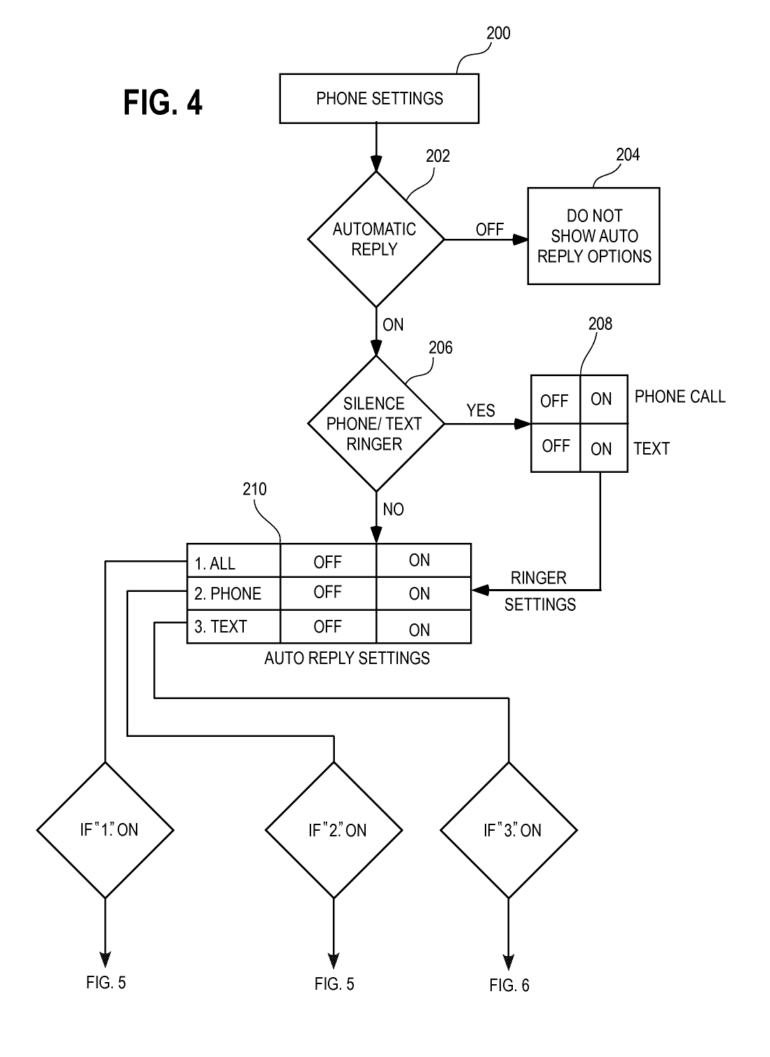

With reference to FIGS. 4-6, the automatic reply function of the phone 100 can be enabled, for example, via on-screen menu options. Specifically, as shown in FIG. 4, the user of cellular phone 100 can enable the phone 100 to automatically reply to phone calls and text messages incoming from pre-specified phone numbers or contacts by accessing an on screen menu option on the phone 100 entitled, for example, “PHONE SETTINGS” 200, and setting the “AUTOMATIC REPLY” function 202 to “ON.” When the user of cellular phone 100 does not desire to enable automatic reply and the “AUTOMATIC REPLY” function 202 is set to “OFF,” the cellular phone 100 does not display any menu options associated with the automatic reply function, as indicated at menu option 204. It will be appreciated that in the embodiment illustrated in FIGS. 4-6, the enabling of the automatic reply on the cellular phone 100 occurs prior to receiving calls and/or text messages on the cellular phone 100.

In the embodiment illustrated in FIG. 4, the enabling of the AUTOMATIC REPLY 202 option on cellular phone 100 permits the user of the cellular phone 100 to silence a ringer on the cellular phone 100 associated with incoming phone calls. For example, if the user of cellular phone 100 may choose to silence phone sounds when the user unavailable to talk and attending a lecture where the user does not want the phone 100 to make sounds typically produced by the phone 100 when receiving incoming phone calls or text messages.

Specifically, when the “AUTOMATIC REPLY” function 202 of the phone 100 is enabled (i.e., set to “ON”), the user of the phone 100 is presented with an option to enable the “SILENCE PHONE/TEXT RINGER” 206 option of the automatic reply on-screen menu. At menu option 206, the user is permitted to select whether ringer and/or the sounds associated with incoming phone calls and/or text messages are silenced or not when the AUTOMATIC REPLY 202 is “ON.”

If the user selects to silence either the incoming call or the incoming text ringer, i.e., if the answer at menu option 206 is “YES,” the on-screen menu of the phone 100 proceeds to menu option 208, where the user can select whether the ringer associated with incoming phone calls is set to “OFF” or “ON” and whether the ringer (or sound) associated with incoming text messages is set to “OFF” or “ON.” If the silence ringer option associated with incoming phone calls is set to “ON” in menu option 208, the cellular phone 100 will not generate a sound which would normally be produced during an incoming phone call when the SILENCE PHONE 208 is not enabled. Instead, since the user of the phone 100 wants to be unavailable to, and may be disrupted by, incoming phone calls, the cellular phone 100 would produce no sounds when an incoming call is being received.

With the ringer settings being set to either “OFF” or “ON” for one or both of the phone calls and text messages at menu options 206 and 208 of FIG. 4, the method of enabling the automatic reply proceeds to menu option 210 entitled “AUTO REPLY SETTINGS.” The AUTO REPLY SETTINGS 210 menu option of the phone 100 permits the user of the phone 100 to select from one of six available exemplary options. Specifically, the first two options are in field “1.” entitled “ALL,” which can enable or disable both voice auto reply settings and text message auto reply settings. Other options in the AUTO REPLY SETTINGS 210 are in field “2.” entitled “PHONE” that can enable or disable automatic reply to incoming phone calls. Other options in the AUTO REPLY SETTINGS 210 are in field “3.” entitled “TEXT” that can enable or disable automatic reply to incoming text messages.

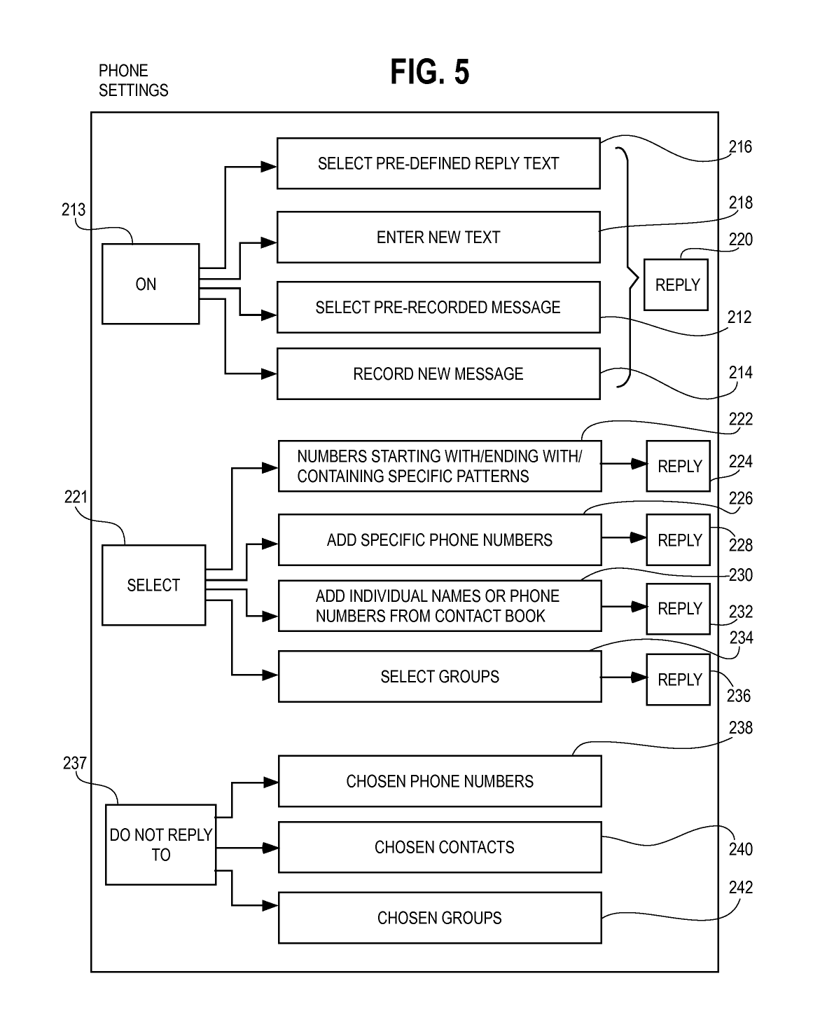

If either of the “ALL” or “PHONE” options in menu 210 of FIG. 4 is set to “ON,” the “PHONE SETTINGS” menu of phone 100 provides the user with multiple options under the exemplary menu field “ON” 213 for generating one or more voice messages and/or text messages for the automatic reply. With specific reference to FIG. 5, the user can select a pre-recorded message at menu option 212. For example, the cellular phone 100 may include multiple pre-recorded or computer-generated generic “unavailable” messages for a user to select from, including, but not limited to: “I am in a meeting, will call you in one hour;” “I am playing tennis, will call when I am done;” “I finished the project you are asking about;” “I will be flying for the next five hours and will call you when I land,” or the like. Alternatively, if the user desires to make the voicemail more specific or personal to a particular person whose phone call the user is expecting, the user of the phone 100 is permitted to record a new voice message at menu option 214. The pre-recorded voice messages and the newly recorded voice messages can be stored in an internal memory of the phone 100, or on a remote server in communication with the phone 100.

With reference to FIG. 5, the user of the phone 100 is also permitted to select a pre-generated (i.e., a template) text message at menu option 216. For example, the cellular phone 100 may include multiple pre-defined computer- or user-generated “unavailable” text messages for a user to select from, such as the exemplary ones described above with reference to generic “unavailable” voicemails. Alternatively, if the user of the phone 100 wants to make the text message more specific or personal to a particular person whose text message the user is expecting, the user of the phone 100 can manually enter a new text message at menu option 218. The pre-defined voicemail messages selectable in menu option 212, recorded new voicemail messages selectable in menu option 214, pre-defined text messages selectable in menu option 216, and recorded new text messages at menu option 218 are referred to collectively herein as a “REPLY” as indicated at box 220 of FIG. 5. The pre-recorded text messages and the newly-generated text messages can be stored in an internal memory of the phone 100, or on a remote server in communication with the phone 100.

The next step in the process for enabling the automatic reply is associating the Reply 220 (i.e., the selected voice message, text message, or both) with at least one phone number for receiving the Reply 220. In particular, as shown in FIG. 5, the user of the phone 100 is presented with a menu field “SELECT” 221 that permits the user to select one or four exemplary menu options that govern which incoming callers automatically receive the Reply 220.

As shown in FIG. 5, at menu option 222, the user of the phone 100 can select numbers starting with, or numbers ending with, or numbers containing a specific pattern for receiving the automatic reply voice message. If option 222 is selected, the cell phone 100 will play or send an appropriate Reply 224 when an incoming phone call is detected (e.g., via caller ID, or other suitable means) by the phone 100 from the user-selected phone numbers starting with, ending with, or containing a specific pattern. As such, the voice messages generated by the user for automatic Reply 224 are associated with a respective one of the phone numbers starting with, ending with, or containing a specific pattern selected at option 222.

As shown in FIG. 5, the user of the phone 100 is also permitted, at menu option 226, to select one or more specific phone numbers for receiving the automatic reply voice message. If one or more specific phone numbers are selected by the user at option 226, the cell phone 100 will automatically send a Reply 228 when an incoming phone call is detected by the phone 100 from the specific phone number or phone numbers specifically selected by the user. As such, each of the voice messages generated by the user for the Reply 228 is associated with specific phone number selected by the user at option 226.

As further shown in FIG. 5, the user of the phone 100 is also permitted, at menu option 230, to select one or more names of individuals from the user's list of Contacts stored on the phone 100 for receiving the automatic reply voice message. If one or more names of individuals (or phone numbers) from the Contacts are selected by the user at option 230, the cell phone 100 will automatically send a Reply 232 when an incoming phone call or text message is detected by the phone 100 from the names or phone numbers of the contacts selected by the user. As such, the voice messages generated by the user for the Reply 232 are associated with a respective one of the names and/or phone numbers included in the user's list of Contacts selected by the user at option 230.

With further reference to FIG. 5, the user of the phone 100 is also permitted, at menu option 234, to define and select one or more groups of individuals for receiving the automatic reply voice message. An example of such a group could be, for instance, “Family,” “Friends,” “Acquaintances,” “Co-Workers,” “Classmates,” or the like. If one or more groups are selected by the user at option 234, the cell phone 100 will automatically send a Reply 236 when an incoming phone call is detected by the phone 100 from a member or members of the group selected by the user. As such, the voice and/or text messages generated by the user for the Reply 236 are associated with a respective one of the groups selected by the user at option 234.

When the automatic reply of the phone 100 is enabled, upon detecting the number or numbers, the name or names, or member or members of the group or groups selected in options 222, 226, 230, and 234 when a phone call from such a number, name, or member of a group is received by the cellular phone 100, the cellular phone 100 automatically plays the pre-selected voice message in a respective Reply 224, 228, 232, and 236 to the person making the incoming phone call. The cellular phone 100 automatically plays the pre-selected voice message without requiring the physical presence of the user or any manual input from the user of the cellular phone 100 when the call from the pre-selected number, name, or group member is being received.

Optionally, the user of the cellular phone 100 may select a number of rings after which the automatic Reply 224, 228, 232, or 236 would play to a person making the incoming call. This option provides the user of the phone 100, when unavailable, with the ability to save the person making the incoming call from waiting through a large number of rings before listening to the automatic reply message. The number of rings selected by the user may be zero (i.e., the automatic reply would turn on without any rings), 1, 2, 3, or more, as desired by the user of the phone 100.

In addition to selecting which phone numbers, individuals, and/or groups receive the voice message in automatic Reply 224, 228, 232, or 236, the user can also select which phone numbers, individuals, or members of a group will not be receiving an automatic Reply when calling the phone 100. For example, under menu field “DO NOT REPLY TO” 237, at option 238, the user of the phone 100 can select one or more “CHOSEN PHONE NUMBERS” (previously selected in option 222 and/or 226), at option 240, the user can select one or more “CHOSEN CONTACTS” (previously selected in option 230), or under option 242, the user may select one or more “CHOSEN GROUPS” (previously selected in option 234) that will not be receiving an automatic reply when calling the phone 100. When the “DO NOT REPLY TO” option 237 is selected by the user of the phone 100, for example, for one or more “CHOSEN PHONE NUMBERS,” when an incoming call is detected by the phone 100 from any of such phone numbers, the phone 100 will not play an automatic Reply voice message to these phone numbers. Accordingly, the phone calls from the phone numbers in the “DO NOT REPLY TO” list of the phone 100 will receive a generic “Leave A Message” voicemail and will be able to leave a message and wait for a call from the user.

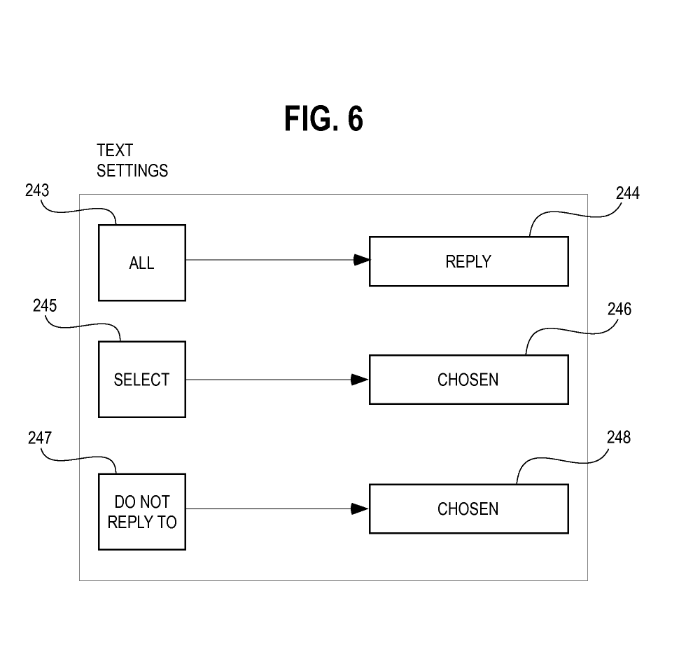

With reference to FIG. 6, the TEXT SETTINGS available to the user of the phone 100 when enabling the automatic reply function of the phone 100 are shown and described. If the user of the phone 100, when unavailable, would like all people that send text messages to the phone 100 to receive in response the same text message, which was selected at option 216 or 218 of FIG. 5, the user would simply enable “REPLY” 244 under the field “ALL” 243 of the TEXT SETTINGS. Alternatively, If the user of the phone 100, when unavailable, desires that specific phone numbers, people, or groups that send text messages to the phone 100 receive specific respective text messages, which were selected at option 216 or 218 of FIG. 5, the user would simply enable the “CHOSEN” 246 option under the field “SELECT” 245 of the TEXT SETTINGS.

When the option “CHOSEN” 246 is selected by the user, upon detecting the number or numbers, the name or names, or member or members of the group or groups selected in options 222, 226, 230, and 234 of FIG. 5 when a text message from such a number, name, or member of a group is received by the cellular phone 100, the cellular phone 100 automatically sends a text message pre-selected by the user of the phone 100 in option 216 or 218 to the person that sent the incoming text message to the phone 100. As described above, the cellular phone 100 automatically responds to the user-specified numbers (e.g., specified under 222 and 226), names (e.g., specified under 230), or groups (e.g., specified under 236) with user-specified text messages without requiring the physical presence of the user or any manual input from the user of the cellular phone 100 after the text message from the pre-selected number, name, or group member is received.

In addition to selecting which phone numbers, individuals, and/or groups automatically receive the text message in the automatic response “CHOSEN” 246, the user of the phone 100 can also select which phone numbers, individuals, or members of a group will not be receiving a pre-selected automatic text message in response when sending text messages to the phone 100. For example, under the field “DO NOT REPLY TO” 247, the user of the phone 100 can select, in option 248, one or more “CHOSEN” numbers (previously selected in option 222 and/or 226), contacts (previously selected in option 230), or groups (previously selected in option 234) that will not be receiving a pre-selected personalized automatic reply text message from the user of the phone 100 when sending a text message to the phone 100. When the “DO NOT REPLY TO” option 247 is selected by the user of the phone 100, when an incoming call is detected by the phone 100 from a number, person, or member of a group selected at the option “CHOSEN,” the phone 100 will not send an automatic text message to such numbers or people. Accordingly, the people on the “DO NOT REPLY TO” list will only receive a responsive text message from the user of the phone 100 when the user is available and manually enters a responsive text message to such people.

The cellular phone 100 described herein can be any cellular phone capable of recording voicemail and sending text messages. The phone 100 may be a smart phone, a tablet, a touch screen cellular phone, or a conventional cellular phone that relies solely on input keys. The phone 100 may be run on any operating system, for example, Apple OS, Android, or the like.

The above described methods of automatically replying to incoming phone calls and text messages advantageously provide cell phone users with the ability to automatically play personalized voice messages and/or automatically send personalized text messages when the users are unavailable to personally respond to incoming phone calls and text messages. The above described methods advantageously permit cell phone users to send automatic personalized responsive voice messages or text messages to pre-selected phone numbers, individuals, or groups of people making an incoming call or sending an incoming text message to the cell phone users without manually manipulating the users' cell phones as the incoming calls or text messages are received.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

What is claimed is:

1. A method of automatically replying to incoming phone calls, the method comprising:
enabling automatic reply on a cellular phone of a user;
generating a voice message for the automatic reply;
associating the voice message with at least one phone number;
detecting the at least one number when an incoming call from the at least one phone number is received at the cellular phone; and
playing the voice message associated with the at least one number to a person making the incoming call from the at least one phone number without requiring manual input from the user of the cellular phone when the incoming call from the at least one phone number is being received.

2. The method of claim 1, wherein the enabling of the automatic reply further comprises silencing a ringer associated with the incoming phone call on the cellular phone.

3. The method of claim 1, wherein the enabling of the automatic reply on the cellular phone includes enabling the automatic reply on the cellular phone prior to the incoming phone call being received at the cellular phone.

4. The method of claim 1, wherein the generating of the voice message further comprises storing a plurality of voice messages on the cellular phone and selecting one of the plurality of voice messages stored on the cellular phone.

5. The method of claim 1, wherein the generating of the voice message further comprises recording a new voice message for storage on the cellular phone.

6. The method of claim 1, wherein the associating of the voice message with the at least one phone number further comprises defining a single phone number for receiving the voice message when calling the cellular phone of the user.

7. The method of claim 1, wherein the associating of the voice message with the at least one phone number further comprises defining a group of phone numbers for receiving the voice message when calling the cellular phone of the user.

8. The method of claim 7, wherein the group of numbers is selected from one or more of the following groups: family, friends, acquaintances, and work-related.

9. The method of claim 1, wherein the detecting of the at least one number when a call is received at the cellular phone comprises detecting a name associated with the at least one number calling the cellular phone.

10. The method of claim 1, wherein the playing of the voice message associated with the at least one number includes playing the voice message automatically after a predetermined number of incoming phone rings.

11. A method of automatically replying to incoming text messages, the method comprising:
enabling automatic reply on a cellular phone of a user;
generating a text message for the automatic reply;
associating the text message with at least one phone number;
detecting the at least one number when an incoming text from the at least one phone number is received at the cellular phone; and
sending the text message associated with the at least one number to a person that sent the incoming text from the at least one number without requiring manual input from the user of the cellular phone after the incoming text message from the at least one phone number is received.

12. The method of claim 11, wherein the enabling of the automatic reply further comprises silencing one of a sound function and vibrate function on the cellular phone associated with the incoming text message.

13. The method of claim 11, wherein the enabling of the automatic reply on the cellular phone includes enabling the automatic reply prior to the incoming text message being received at the cellular phone.

14. The method of claim 11, wherein the generating of the text message further comprises storing a plurality of text messages on the cellular phone and selecting one of the plurality of text messages stored on the cellular phone.

15. The method of claim 11, wherein the generating of the text message further comprises inputting a new text message for storage on the cellular phone.

16. The method of claim 11, wherein the associating of the text message with the at least one phone number further comprises defining a single phone number for receiving the text message when sending a text message to the cellular phone of the user.

17. The method of claim 11, wherein the associating of the text message with the at least one phone number further comprises defining a group of phone numbers for receiving the text message when sending a text message to the cellular phone of the user.

18. The method of claim 17, wherein the group of phone numbers is defined from a list of contacts of the user stored on the cellular phone.

19. The method of claim 17, wherein the group of numbers is selected from one or more of the following groups: family, friends, acquaintances, and work-related.

20. The method of claim 11, wherein the detecting of the at least one number when a text message is received at the cellular phone comprises detecting a name associated with the at least one number from which the incoming text message is sent to the cellular phone.
